(19) United States
(12) Patent Application Publication
(10) Pub. No.: US 2025/0128963 A1
(43) Pub. Date: Apr. 24, 2025

(54) Portable Water Filtration Apparatus and Method

(71) Applicant: Paul W. O'Brien, Pleasant Mount, PA (US)

(72) Inventor: Paul W. O'Brien, Pleasant Mount, PA (US)

(21) Appl. No.: 18/745,852

(22) Filed: Jun. 17, 2024

Related U.S. Application Data
(60) Provisional application No. 63/508,414, filed on Jun. 15, 2023.

(51) Int. Cl. C02F 1/00; C02F 103/00

(52) U.S. Cl. CPC C02F 1/002; C02F 2103/007; C02F 2201/004; C02F 2201/005; C02F 2301/063

(57) ABSTRACT

A portable water filtration device including a holding chamber and a filtration chamber containing at least one filter media and configured to telescope with said holding chamber, a suction end adapter connected to the distal end of the holding chamber, and an outlet adapter coupled over the outlet end of the filtration chamber having a pair of opposite outwardly extending finger grips connected to a side wall of the cap section, wherein water is drawn into the holding chamber and then into the filtration chamber by a pumping action, and a pre-filter configured to be secured to the suction end adapter by a friction fit, and a channel extending through the adapter portion of the pre-filter configured to connect to a free end of the tubular member connected to the outlet adapter also by a friction fit to enable cleaning of the pre-filter by reverse flushing water through said pre-filter.

### REFERENCE TO RELATED APPLICATION

This application is a nonprovisional of co-pending U.S. Provisional Patent Application Ser. No. 63/508,414, titled “Portable Water Filtration Apparatus and Method”, filed on 15 Jun. 2023, by the same inventor herein, the entirety of which is hereby incorporated by reference.

### BACKGROUND OF THE INVENTION

### 1. Field of the Invention

The present invention relates generally to portable devices and methods for removing contaminants from water supplies and enhancing the safety and taste of the water, and more particularly to embodiments of a lightweight portable water filter apparatus including a manual pump assembly having a piston-like filtering chamber.

### 2. Description of Related Art

Contaminated water for drinking or domestic use is a leading health risk worldwide. Poor quality water is particularly prevalent in developing countries, where everyday life may be largely centered around access to potable drinking water, but water supplies in more developed countries also poses health risks. The two main sources of drinking water are surface water originating from reservoirs, lakes, rivers, and the like, and ground water pumped from aquifers. Surface water sources are generally more polluted than ground water, although increasingly ground water is contaminated by runoff from landfills and agricultural residues. Bacterial and viral contaminants are present in virtually all water sources, although the concentration of viral contaminants in water is typically higher in rural areas and developing countries. Emerging contaminants such as microplastics, pharmaceuticals, per- and polyfluoroalkyl substances (PFA's), and various pesticides are becoming more problematic. Aging water system infrastructures, lack of proper maintenance, and political uncertainties have also negatively affected water supplies. Low-income and rural areas in general are more at risk of having contaminated drinking water, as they are less able to afford newer treatment technologies, and the initial quality of the source water is more likely to be highly contaminated and require more extensive treatment. Commercially bottled water has become popular in some countries such as the U.S., where the safety standards for bottled water are based on the EPA standards for tap water. Nevertheless, bottled water can also be contaminated with microbial, physical and/or chemical hazards as a result of poor manufacturing practices. In addition, plastic bottles are both wasteful and environmentally harmful.

Travelers and hikers, both nationally and internationally, are also more at risk of encountering a contaminated water supply. For hikers in remote areas, the only available water source in an emergency may be untreated surface water from a stream or river. Illnesses caused by microscopic contaminants commonly found in untreated water include diarrhea, giardiasis, dysentery, typhoid fever, E. Coli infection, and salmonellosis. In many cases, these such ailments can be treated if attended to quickly, but if not treated can worsen and cause permanent serious conditions as well as death, particularly in the young, elderly, and those having a compromised immune system.

Portable water filtration devices for treating water originating from potentially contaminated water supplies such as untreated surface water, ground water from a well, improperly maintained public water systems, and even bottled water are known. One example is a small straw-type device wherein the user places his or her mouth on a mouthpiece attached over one end of an elongated casing while the opposite end is dipped into a water supply. The user will “suck” inwardly as with a conventional straw, which will create a lower or negative air pressure relative to atmospheric pressure in the casing and cause water to be drawn up into the casing, across one or more filter mediums in the casing and then into the user's mouth. The lower pressure created must also be sufficient to cause the water to pass through the filters. There is a practical limit as to the number or thickness of the filters, as well as to the pore sizes of the filters, while still allowing an adequate water flow through the device. Membrane filters work by retaining particles on the membrane surface that are larger than the membrane pore size, while depth filters use a porous filtration medium that also retains particles throughout the filter, rather than just on the surface, and therefore retains a high load of particles. In either case, the smaller the pore size the more contaminants will be removed from a solution passed through the filter. With straw-type filtration devices, however, the pore size of the filter cannot be made too small because it then becomes overly difficult to draw water through the filter with just manual “sucking”. The pore size of membrane filters used in suction-type straw filtration devices therefore may be larger than many harmful contaminants, such as viruses. For example, a pore size of 4.0 microns will filter out Giardia cysts, and a maximum pore size of 0.2 microns is required to filter out all bacteria, which generally have a diameter of between 0.2 and 10 microns. Viruses typically range in size from 0.0004 to 0.1 microns and thus are too small to be filtered out by the most conventional membrane filters usable in straw-type filter devices. Ultrafiltration includes filters from 1 nanometer to 100 nanometers, and retains viruses within this range, but the amount of water that can be passed through conventional ultrafiltration filters is insufficient for use in a manual straw filter device. There therefore remains a need for a portable water filtration device which is equally small and lightweight as straw-type filters but which can filter out contaminants of all sizes, including viruses.

In view thereof, the present inventor has developed a lightweight, durable portable filtration device which is dimensioned to be easily carried in a backpack, carry-on luggage, or clothing pocket, in some embodiments weighs less than 3.5 ounces, and that is capable of effectively filtering most bacteria, viruses, cysts, chemical toxins, microplastics, trace pharmaceuticals, and other contaminants from the water.

### SUMMARY OF THE INVENTION

The present invention comprises a portable water filtration device including a manually operated pump assembly having an elongated tubular holding chamber and an elongated tubular filtering chamber which is slidable within an interior of the holding chamber. The holding chamber of the water filtration device has a suction end which is inserted either directly in a water supply or indirectly via an extension tube accessory, and an upper end. The filtration chamber has an inlet end and an outlet or “discharge” end. An adapter having an opening in which the filtration chamber is slidingly received and including an airtight gasket is coupled to the upper end of the holding chamber. The outlet end of the filtration chamber extends out the holding chamber. Water is drawn into the suction end of the holding chamber by operation of the manual pump assembly. An adapter having an inlet opening or passageway containing a one-way valve is secured over the suction end of the holding chamber which allows fluid to flow into the holding chamber through the valve but not a reverse flow. Prior to entering the filtration chamber through the one-way valve, the water is passed through a pre-filter which in some embodiments is a screen positioned over the inlet opening having a screen size which filters most large physical contaminants from the water supply before passing into the holding chamber.

The pump assembly utilizes a pumping action to create a reduced or negative pressure relative to atmospheric pressure at the inlet opening to the holding chamber, which is produced upon sliding the filtering chamber upwardly out of the holding chamber. This movement of the filtering chamber acts as a pump piston for the pump assembly, and the negative pressure relative to atmospheric pressure created by sliding the filtering chamber outwardly allows atmospheric pressure to force water from the source through the inlet opening into the holding chamber. The negative pressure generated in the holding chamber allows the pre-filter to have a comparatively smaller screen size and to exclude smaller contaminants without a substantial reduction in water flow than is possible with conventional straw-type filtration devices. Water drawn into the holding chamber is then forced through another one-way valve in an adapter coupled to the inlet end of the filtering chamber by a positive pressure when the filtering chamber is slidingly returned into the holding chamber. Once in the filtering chamber, as the volume of water in the filtering chamber increases it is moved from the inner end towards the outer and is passed across one or more filter members housed in the filtering chamber. The water is then directed out of the outlet end or “discharge” end of the filtering chamber. Other portable water filters that can filter contaminants to a pore size of 0.1 micron are much larger and bulkier and are harder to carry and store than the present device.

Various adapters and accessories can be selectively utilized with the portable water filtration device. In some embodiments, a mouthpiece may be provided to facilitate directly drinking of clean water from the filtration device, while in some other embodiments, a flexible hose is secured to the discharge end which facilitates directing the clean, filtered water to a desired location such as into a storage container. In some other embodiments, the flexible hose is a short hose secured to the discharge end, and a resilient band member is provided which is securable over the flexible hose. The band member is utilized to maintain the flexible hose in a smoothly rounded or curved position without requiring manual holding of hose. The user's one hand will be gripping the outer holding chamber while the other hand is sliding the filtering chamber in and out of the holding chamber. The band member thus holds the flexible hose in a curved position and makes it easier to direct the clean water flow exiting the device directly into a storage container such as a water bottle or the like. The resilient band member can be removed from and then re-connected over the flexible hose as needed. In some embodiments, the discharge end adapter may have one or more flanges or ears coming out of the base of the accessory. The flanges provide the user with a gripping surface on the filtering chamber and better enable the user to pull upwardly with two fingers against the flanges to slide the filtering chamber out of the holding chamber and then push the filtering chamber back into the holding chamber. In addition, in some embodiments a plug or adapter having an outwardly extending nipple for attaching a flexible hose to the nipple is securable to the suction end of the holding chamber. The loose or outlet end of the flexible hose may be fitted with a small adapter which houses a pre-filter screen member and which can be placed in a water source such that water from the water source can be drawn through the flexible hose into the suction end of the holding chamber. As a result, the user does not have to manually hold the suction end of the filtration device in the water source, which can be awkward and difficult for some. In an embodiment, an adapter for coupling the flexible hose attached to the suction end of the device to a water bladder for a portable hydration pack is provided. In another embodiment, the device includes a pre-filter which is reverse flushable by connecting to the tubular member attached to the filtration chamber exit outlet. In another embodiment, the filtration chamber includes a window area wherein filtered water passing through the filtration chamber and filter membrane can be observed and the condition of the filter visually monitored by the user.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an embodiment of the portable water filtration device of the present invention.

FIG. 2 is a longitudinal cross-sectional view of the water filtration device as shown in FIG. 1.

FIG. 3a-3e illustrate a snap-on nipple adapter arrangement for connecting to the “suction” end of water filtration device of the present invention.

FIG. 4 illustrates an extension hose accessory adapted for use with the present invention.

FIG. 5 illustrates the filtration device as adapted for use with a water bladder back pack.

FIG. 6a-6e illustrate an alternative outlet end cap member for use with the present invention.

FIG. 7 is side elevation view of an embodiment of the present invention.

FIG. 8 illustrates use of the present invention to filter water into a storage container with the band member holding the flexible discharge tube in a rounded position.

FIG. 9 illustrates another alternative embodiment of the water filtration device.

FIG. 10 illustrates another alternative embodiment of the water filtration device.

### DESCRIPTION OF THE PREFERRED EMBODIMENTS

Reference will now be made in detail to embodiments of the present invention, examples of which are illustrated in the accompanying drawings. While the present invention will be described in conjunction with the several embodiment(s), the description is not intended to be understood in a limiting sense, but to be an example of the invention presented solely for illustration thereof, and by reference to which in connection with the following description and the accompanying drawings one skilled in the art may be advised of the advantages and benefits of the invention. On the contrary, the present invention is intended to cover alternatives, modifications, and equivalents, which may be included within the spirit and scope of the invention as defined by the appended claims. Further, it will be appreciated that embodiments of the present disclosure may employ any combination of features described herein. Descriptions of well-known starting materials, equipment, components, and processing techniques may be omitted so as to not unnecessarily obscure the embodiments herein.

In the description of the invention, the terms “upper,” “lower,” “inner,” “outer,” “top,” “bottom,” “left,” “right,” and like terms refer to orientations or positions based on those shown in the drawings. The terms are only for the convenience and simplification of the description of the present invention, rather than indicating or implying that the device or element referred to must have a specific orientation or be constructed and operated in a specific orientation. The terms “first” and “second” do not represent the importance of components, and therefore cannot be construed as limiting the present invention. When terms such as “first” and “second” are used herein to modify a noun, such use is simply intended to distinguish one item from another and is not intended to require a sequential order unless specifically stated.

The specific dimensions used in describing the embodiments are only for illustrating the technical solution without limiting the protection or scope of the present invention. Reference herein to “an embodiment,” “another embodiment,” and like terms means that a particular feature, structure, or characteristic described in connection with the embodiment is included in at least one embodiment of the disclosure. The phrases “in an embodiment” or “in some embodiments” as used herein are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and like terms are to be construed in an inclusive sense, as opposed to an exclusive or exhaustive sense; that is to say, in the sense of “including, but not limited to.” As used herein, the terms “connected,” “coupled,” “joined,” or any variant thereof, means any connection or coupling, either direct or indirect, between two or more elements. If the specification states a component or feature “may,” “can,” “could,” or “might” be included or have a characteristic, that particular component or feature is not required to be included or have the characteristic.

As used herein, the singular forms “a,” “an,” and “the” include plural references unless the context clearly dictates otherwise. Unless defined otherwise, all technical and scientific terms used herein have the same meanings as commonly understood by one of ordinary skill in the art. When used in this document, the term “exemplary” is intended to mean “by way of example” and is not intended to indicate that a particular exemplary item is preferred or required.

The present invention is directed to a portable water filtration device including a pump assembly wherein by operating the pump water is drawn into a holding chamber by a negative pressure and then is forced by a positive pressure into a filtration chamber in which one or more filters for filtering filter contaminants from the water are housed, after which the water is then dispensed from the discharge end of the filtration chamber ready for drinking or other domestic use or activities. The filtration chamber or inner chamber is telescoping with respect to the holding or outer chamber. The holding chamber has an adapter coupled to a suction or inlet end having an inlet opening and a pre-filter covering the inlet opening. In some embodiments, the suction end with the pre-filter attached is inserted directly into a water source to be filtered, or in other embodiments a tubular accessory is secured to the suction end and the pre-filter is attached to the tubular accessory and submerged in the water source. The filtration chamber is then slidingly pulled out of the opposite end of the holding chamber, which creates a negative pressure in the holding chamber and draws a volume from the water source through the pre-filter and then through a one-way check valve into the holding chamber. Then, the filtration chamber is moved telescopingly back into the holding chamber, which creates a positive pressure in the holding chamber and forces the water in the holding chamber to be gradually passed into the filtration chamber through a one-way valve on the inlet end of the filtration chamber. Upon entering the filtration chamber, the water is then forced across one or more filtering mediums. The pump assembly enables a satisfactory water flow through the filtration device across a membrane filter described herein having significantly smaller pore sizes as compared to conventional straw-type water filtering devices, providing improved results at a relatively low cost.

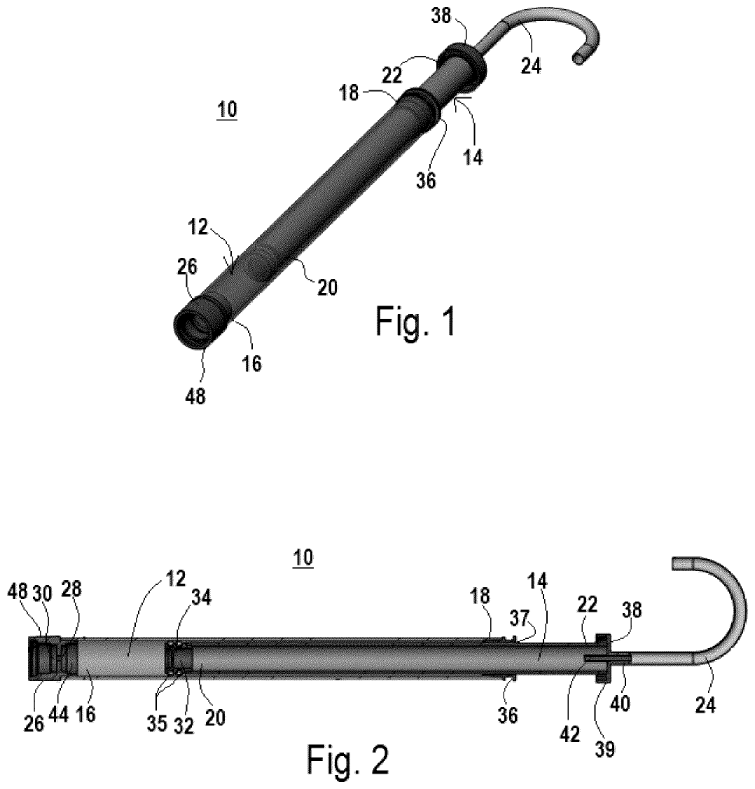

Referring now in particular to FIGS. 1-2, there is shown an embodiment of the water filtration device 10 in accordance with the present invention. Filtration device 10 has an elongated outer chamber or fluid holding chamber 12, an elongated inner chamber or fluid filtration chamber 14 that is telescopingly slidable within an interior of holding chamber 12, and a tubular member 24 attached to the filtration chamber 14 through which filtered water is dispensed for use. In an embodiment, holding chamber 12 and telescoping filtration chamber 14 are made of a thermoplastic polymer such as polypropylene and have a tubular or cylindrical configuration, while in other embodiments, the chambers 12 and 14 may be made from other materials, and may have other shapes while still falling within the scope and accomplishing the intended purposes of the invention. Holding chamber 12 has a distal or “suction” end 16 and a proximal end 18. Filtration chamber 14 has an inlet end 20 and an outlet or “discharge” end 22. A suction adapter 26 having a one-way inlet valve 28 and inlet pre-filter or screen 30 is coupled to the open distal end 16 of holding chamber 12. A plug adapter 32 also having a one-way valve 34 is coupled over the inlet end 20 of filtration chamber 14. Support adapter 36 having an opening in which the filtration chamber 14 is slidably received is coupled over the proximal end 18 of the holding chamber 12. Outlet adapter 38 having a nipple 40 and channel 42 is coupled over the outlet end 22 of filtration chamber 14. Finally, a flexible tubular member 24 is coupled to nipple 40 in some embodiments by a friction fit.

Filtration device 10 preferably has a slim profile, and in an embodiment holding chamber 12 has an outer diameter of 1 inch, an inner diameter of 0.875 inches, and including adapters 26 and 38 has a length of between about eleven and twelve inches. The dimensions of the chambers can vary to accommodate a greater or lesser volume of water in each of the chambers. The embodiment of filtration device 10 in FIG. 1-2 is dimensioned to be carried conveniently on one's person in a duffel bag, shirt pocket, coat, backpack, or the like, and has a weight of less than 4 ounces.

In some embodiments, the “suction” adapter 26 is a plug secured over the open distal end 16 of the holding chamber 12. Adapter 26 has a plug portion 44 which is inserted into the interior of the distal end 26 of holding chamber 12 and is secured by a friction fit with the inner wall, while in some embodiments may be secured using an adhesive or other securing means. Adapter 26 also has an outer cap portion 48 which extends from the distal end 12. A central bore or passageway connects between the cap portion and plug portion. One-way check valve 28 is mounted in the central bore and allows fluids to flow through the check valve 28 into the holding chamber 16 but prevents such liquids from reverse flowing out of holding chamber 12 through valve 28 via the passageway. Pre-filter 30 is secured to the adapter 26 extending over the entrance to the check valve 28. In some embodiments, the pre-filter 30 is a screen member which is secured in the outer cap portion 48 over the entrance to the central bore, and has a pore size that prevents particulate matter, sediment and like larger contaminants from entering the check valve 28 and the holding chamber 12, as such larger particles would quickly clog the check valve 28. The outer end of the cap portion 48 is open to allow water to flow to pre-filter 30.

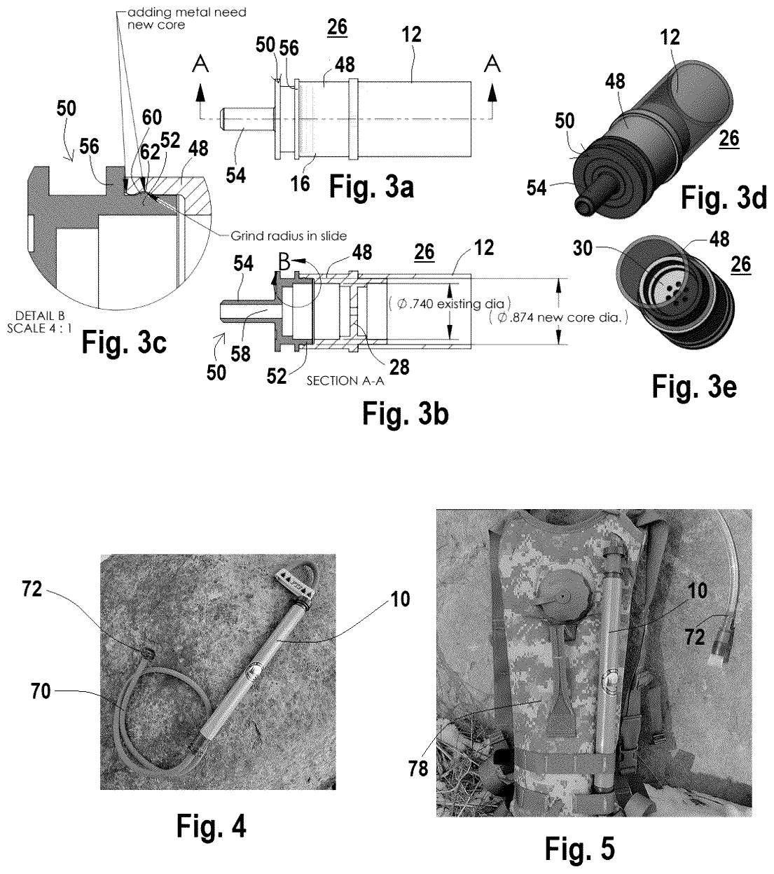

FIG. 3a-3e illustrate another embodiment of the “suction” end adapter 26 for connecting to the distal end 16 of the water holding chamber 12, along with a nipple adapter 50 which is secured to the outer cap portion 48 of adapter 26. As best shown in FIG. 3c, which is a closeup view of the connection between end adapter 26 and nipple adapter 50 indicated in FIG. 3b, nipple adapter 50 has an inner section 52 which is inserted in the outer cap portion 48, and an outwardly directed nipple 54. A peripheral lip 56 is positioned adjacent inner section 52, and a channel 58 connects between nipple 54 and inner section 52 to allow fluid to pass through the nipple 54 into the adapter 26 and then the holding chamber 12. In some embodiments, as shown in FIG. 3c, nipple adapter 50 also has a tab 60 on the outer wall of inner section 52 which is positioned to be received in or “snap fit” with recess 62 in the inwardly facing wall of outer portion 48 of the adapter 26 to secure the nipple adapter 50 to the “suction” end adapter 26.

FIG. 4 illustrates the filtration device 10 having an extension hose accessory 70 secured to the “suction” end adapter 26 of the holding chamber 12. Extension hose 70 has fitting 72 secured over the outer end of hose 70 which may hold another pre-filter or screen to prevent large particles from entering the extension hose 70. In some embodiments, the extension hose 70 may be a three-foot hose while in other embodiments it may be a shorter or longer hose as needed. In some embodiments, the inner end of the extension hose is secured to outer cap portion 48 of “suction” end adapter 26 by a friction fit with an interior of the outer cap portion 48, while in other embodiments the inner end of hose 70 is secured to by a friction fit over the nipple 54 illustrated in FIGS. 3a discussed above. FIG. 5 illustrates another embodiment of the present invention wherein the fitting 72 on the outer end of the extension hose 70 as shown in FIG. 4 is adapted to be connected to a hose of a hydration water bladder 78 of a type which in some embodiments is configured as a backpack used for hiking, cycling, military operations, and other uses. In FIG. 5, extension hose 70 may only be twelve inches in length or another suitable length. A suitable hose and mouthpiece 72 may also be attached to adapter 38 on the outlet end of the filtration chamber 14. In other embodiments, fitting 72 may be configured to be threadably secured to the mouth of a water bottle or other container. Provision of a “snap-fit” nipple adapter 50 as described above with reference to FIG. 3a-3e to extension hose 70 is secured and that simply snaps into the base of the holding chamber 12 greatly improves the performance of the filtration device for a range of uses. In addition, the same nipple adapter 50 can simply plug into the hose of most standard hydration backpacks making it easy to use in three separate markets.

Referring once again to FIGS. 1-2, adapter or plug 32 is secured to inlet end 20 of inner filtration chamber 14 by a suitable means including but not limited to an adhesive or a threaded connection. Plug 32 has a peripheral outer rim having a pair of aligned notches therein, in which a sealing member such as a rubber ring or gasket 35 is positioned. The gaskets 35 are configured to press against the inner wall of holding chamber 12 and to provide an airtight seal between the interior of the holding chamber 12 and the distal end 20 of the filtration chamber 14 as the filtration chamber 14 is slidingly moved within the holding chamber 12. Other arrangements known to those skilled in the art for providing an airtight fit between outer holding chamber 12 and inner filtration chamber 14 may also be utilized. An internal passageway is formed in plug 32, in which a one-way check valve 34 is secured through which fluid can flow from holding chamber 12 into inlet end 20 of filtration chamber 14 through the passageway, but prevents a reverse flow from filtration chamber 14 into holding chamber 12 through the passageway.

Adapter 36 is secured over the proximal end 18 of holding chamber 12 by a suitable means such as an adhesive or thread connection. In some embodiments, adapter 36 is a collar member having a central orifice 37 in which the filtration chamber 14 is slidingly received. A portion of adapter 36 is fitted into the interior of the proximal end 18 of holding chamber 12, which is configured to prevent adapter 34 on the distal end 20 of the filtration chamber 14 from disengaging from or passing out of outer end 18 of holding chamber 12. Adapter 36 thus secures the filtration chamber 14 in a telescoping relationship with the holding chamber 12.

Adapter 38 is secured over the outlet or “discharge” end 22 of filtration chamber 14 by a suitable means such as an adhesive or thread connection. Adapter 38 has a cap section 39 which fits over the outer wall of the outlet end 22 of the filtration chamber 14, and also has an outwardly directed nipple 40 connected to a top of the cap section having an inward extension and a channel or passageway 42 which connects with the interior of the filtration chamber 14 and through which filtered, clean water is passed out of filtration device 10. Tubular member 24 is attached to nipple member 40 of adapter 38 by a suitable means such as a friction fit or an adhesive and is made of a suitable flexible material. Fluid passing out of filtration chamber 14 through nipple 40 will therefore be directed out of the free end of the tubular member 24.

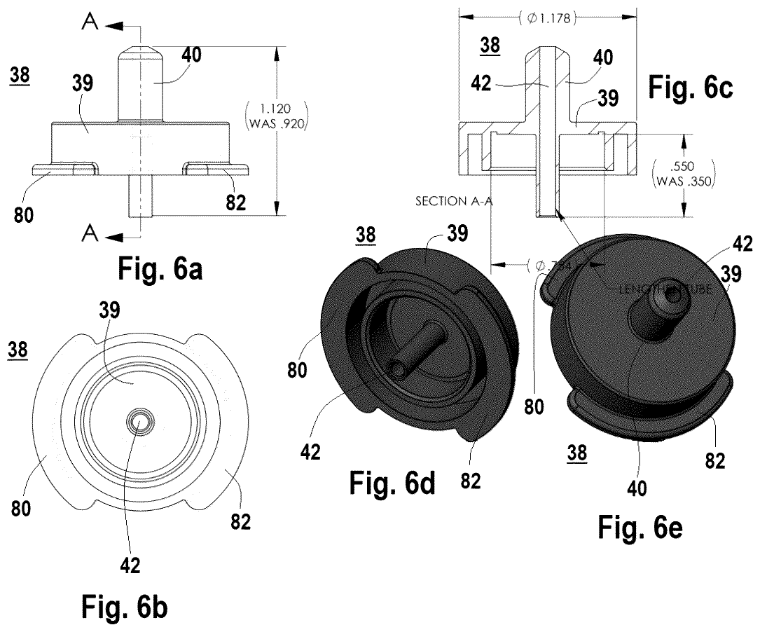

FIG. 6a-6e illustrate another embodiment of outlet adapter 38 which further comprises a pair of opposite outwardly extending finger tabs or grips 80 and 82 integrally formed on opposite sides of the side wall of cap portion 39 of the adapter 38. Finger tabs or grips 80 and 82 extend laterally outwardly from cap portion 39 of the adapter 38 and may be chamfered or rounded along their edges. Tabs 80 and 82 facilitate manual gripping of filtration chamber 14 particularly when manually telescopingly sliding the filtration chamber 14 in and out of the holding chamber 12. In some embodiments, the outer end of the tubular member 24 attached to nipple 40 of adapter 38 may also include a removable cover or cap member (not shown) that is securable over the outer end when device 10 is not in use, in order to prevent dirt and other contaminants from contacting the outer end or entering tubular member 24.

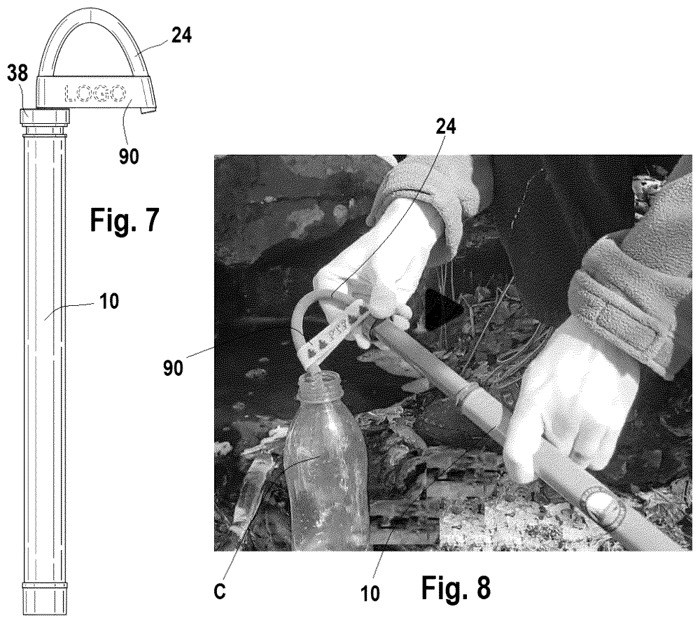

FIGS. 7 and 8 illustrate the short flexible hose or tubular member 24 secured to the discharge end of the portable filtration device 10, and in addition a resilient band member 90 which is positioned or looped over the short flexible hose 24, holding the hose 24 in a bent or rounded, angled configuration, as well a manner of use of the filtration device 10. The band member 90 greatly improves the ease of use of the present invention since it maintains the hose 24 in a stationary position as water is expelled from the filtration device 10. Without the band member 90 secured over the hose 24, when water exits the device 10 through hose 24 the water force or pressure in the hose will cause the hose 24 to move or bend in response to these forces, which makes directing the discharge end of the hose 24 into a small mouth container C difficult, as both of the user's hands are occupied in operating the filtration device 10. The band member 90 maintains the flexible hose in a smoothly rounded or curved position and downward position without manual holding or aiming the hose. The user's one hand will be gripping the outer holding chamber while the other hand is sliding the filtering chamber in and out of the holding chamber. The band member thus holds the flexible hose in a curved position and makes it easier to direct the clean water flow exiting the device directly into a storage container such as a water bottle or the like. The resilient band member can be removed from and then re-connected over the flexible hose as needed. A logo or other indicia or designs may also be printed on the band member 90 such that in some embodiments the band member serves a dual advertising purpose. In some embodiments, the band member 90 is made of a rubber material similar to a rubber band, while in other embodiment the band member 90 may be a sleeve such as a cardboard sleeve configured to receive and hold the hose 24 in a stationary position during use of the device 10.

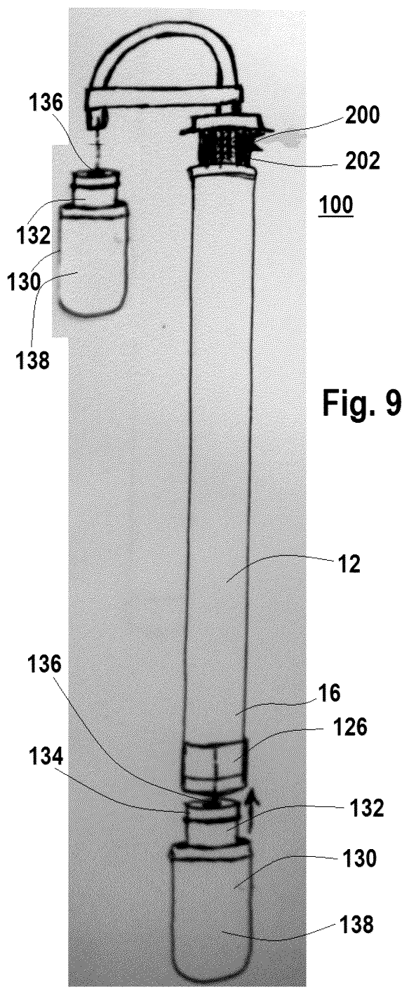

FIG. 9 illustrates another embodiment of the water filtration device 100 wherein the suction adapter 126 on the distal end 16 is configured to receive a pre-filter 130 on the outer end of the adapter 126. Pre-filter 130 has an adapter portion 132 which is configured to be inserted into an opening in the outer end of the adapter 126 wherein in an embodiment is secured by a friction fit in the opening. The adapter portion 132 has a gasket 134 positioned on the outer surface of the adapter portion 132 to prevent leaking when inserted in the adapter portion 132, and a channel 136 extending through the adapter portion 132. In addition, an enlarged filter member 138 is secured to the outer end of the adapter portion 132 through which water to be filtered must pass before entering the channel 136 in the adapter portion 132 and then entering the filtration device 100. The enlarged filter member 138 will filter out smaller debris particles than the screen 30 in suction adapter 26 described above.

In an embodiment, pre-filter 130 is adapted to be removable from the suction adapter 126 and alternatively connected to hose or tubular member on the outlet end of the device 100. In an embodiment, channel 136 in the adapter portion 132 is dimensioned to fit snugly over the outer end of the hose or tubular member 24 where it is secured by a friction fit. This arrangement provides a convenient arrangement for reverse flushing of the pre-filter 130 by passing a clean supply of water through the filtration device which will significantly extend the useful lifespan of the pre-filter 130 as well as the filtration device 100 particularly in embodiments where the device 100 is disposable once the filtering media in the filtration chamber 14 is dirty, but also in embodiments where the filtering media is replaceable in a cartridge form or the like. In addition, the pre-filter 130 is preferably also configured to be attached to the free end of the telescoping hose 70 connected to the suction adapter 38 as shown in FIG. 5 instead of being directly connected to the suction adapter 38.

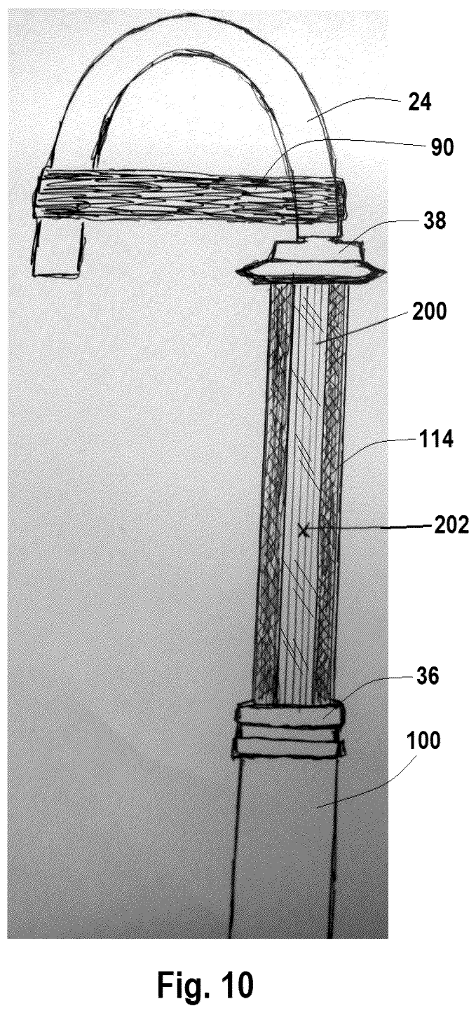

In addition, in some embodiments, a window 200 is formed in the side surface of the filtration chamber 114 through which users can see the water passing within the filtration chamber 114 and the pleated filter member 202. A portion of window 200 is visible in FIG. 9, while in FIG. 10 a larger section of the window 200 is visible. In some embodiments, the window 200 is comprised of a clear strip manufactured into the extruded tube, such that users can visually observe the water flow and monitor for any clogging of the filter media with debris. Since the window 200 becomes visible each time the filtration chamber 114 is pulled out of the outer chamber 12 as part of the pumping action of the device, essentially continuous visual monitoring of the filter media in the filtration chamber 114 is possible. In addition, it has been found that it is pleasing to some users to see the contaminants that have been removed from their drinking water.

In use, a fluid originating from a potentially contaminated water source is drawn through pre-filter 30 in “suction” end adapter 326 of holding chamber 12 as well as the larger pre-filter 130 when connected to adapter 26 by the relatively lower pressure created in holding chamber 12 when filtration chamber/piston 14 is telescopingly moved out of holding chamber 12. In some embodiments, holding chamber 12 may contain at least one disinfectant agent, so that the water drawn into holding chamber 12 may be isolated and in contact with the disinfectant agent for the time period required for the particular agent or agents to destroy or neutralize specific bacteria, viruses and/or protozoa or other contaminants in the water. The filtration device 10 may be gently shaken or twisted back and forth during such time period to ensure that the disinfecting agent completely mixes with the water in holding chamber so that all of such water is properly contacted and sterilized or treated by the agent. In an embodiment the disinfecting agent is an iodine resin which disinfecting agent may be housed in a cartridge, permeable sack or other container. In some embodiments, one or more separate chambers which house ion exchange resins for region specific contaminant treatment and removal such as arsenic and lead can also be incorporated either into the holding chamber or filtration chamber. A charcoal or activated carbon cartridge may also be provided.

The water in holding chamber 12 is moved out of the holding chamber 12 into filtration chamber 14 when the filtration chamber 14 is manually slid back into the holding chamber 14. This movement causes the water in the holding chamber 12 to be displaced from the holding chamber 12 through the one-way valve 34 in inlet end adapter plug 32 of filtration chamber 14. Fluid in filtration chamber 14 is gradually moved from the inlet end 20 to the outlet or “discharge” end 22 of filtration chamber 14 while also being passed through one or more filtration members or units housed in the chamber 14. The fluid is forced out of filtration chamber 14 through the internal channel 42 in adapter 38 in nipple 40 into flexible tube 24. The outer end of tube 24, which can be different lengths or may be connected to an extension tube to extend its length, may be oriented to pass the fluid into a storage container, bucket, or to direct the fluid for another intended use. The “suction” end of the device does not have to be maintained in the water source as the filtration chamber 14 is returned into the holding chamber 12, but rather can be returned into the water source repeatedly until the desired amount of water has been filtered using the device.

As indicated above, the interior of filtration chamber 14 houses one or more filter medias or purifying substances. In some embodiments, the filtration device 10 is intended to be disposable after a pre-determined number of uses before the filters become clogged and the water flow becomes too constricted, while in other embodiments of the device 10 the filtration device 10 can be cleaned, the filters can be replaced in the filtration chamber 14, the pre-filter 130 can be cleaned by reverse flushing, and other components such as the end adapters may be removable and replaceable. In an embodiment, the filtration device 10 is rated to filter 150 gallons or over 1100 (500 ml) bottles of non-turbid water, has passed NSF/ANSI/IAPMO Standards 42, 53, and 61, and reduces Cysts by at least 99.97%. The device 10 is extremely lightweight and in a preferred embodiment weighs only 3.5 oz. In some embodiments, the pre-filter 26 on the suction inlet end of the holding chamber 12 may be removed, cleaned and replaced without requiring other components of the device 10 to be disassembled. Filtration device 10 can accommodate filters or filtering substances having substantially smaller pore sizes than conventional straw-type filtration devices, since the positive and negative pressure generated by the pump assembly forming an integral component of the device enables the water to be easily passed across these smaller pore size filters. Thus, the present device is much more effective in removing microbial contaminants as well as viruses to ensure that the water is potable. Other known straw-type water filtering devices cannot satisfactorily pass a suitable supply of water through a pre-filter or one or more internal filters having a sufficiently small pore size solely by a suction force exerted on a mouthpiece. With the present inventor's filtration device 10, however, the water is easily drawn into holding chamber 12 in reaction to the negative pressure created in such chamber 12 as chamber 14, which has a dual purpose as a piston of the pump assembly and filtration chamber, is moved upwardly out of holding chamber 12. Then, when inner chamber 14 is moved back into holding chamber 12, the resulting positive pressure forces the water to pass through a one-way valve into filtration chamber 14 under pressure, forcing the water across the filters in chamber 14.

Upon initiating use of device 10, inner filtration chamber 14 will start in a retracted position inside holding chamber 12. The bottom or suction adapter 26 is inserted in a water source, and water is drawn into the holding chamber 12 and then forced through the filter chamber 14. This step may be repeated three times before each actual use of the filtration device in order to properly activate the internal filter. The water may be from a lake, stream, or other treated or untreated source. Preferably, the water will be as free of visible contaminants as possible, and may be initially strained through a cotton shirt or cloth or the like into a clean container to remove most very large or easily visible contaminants. After each use of the filtration device 10, the pump assembly should be utilized two or three additional times to try to expel any remaining water from the device chambers. In some embodiments, a storage pouch may be included with the device in which other accessories such as an extension hose may be stored in one place.

In some embodiments, the filter membrane is pleated and comprises an electropositive water filter that can adsorb a broad spectrum of contaminants ranging from large particles to as small as a few nanometers. In some embodiments, the electropositive water filter comprises electropositively charged nano alumina fibers which attract and capture negatively charged contaminants in the water such as bacteria, viruses, cysts and 1,000 chemicals. In some embodiments, a suitable electropositive water filter media is available under the trademark Nanoceram® owned by Argonide Corporation.

The foregoing description has been presented for purposes of illustration and description and is not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated. Although particular constructions of the present invention have been shown and described, other alternative constructions will be apparent to those skilled in the art and are within the intended scope of the present invention.

I claim:

1. A portable water filtration device comprising:
an elongated holding chamber having a distal end and a proximal end;
a filtration chamber having an inlet end and an outlet end, said filtration chamber configured to be telescoping with said holding chamber and containing at least one filter media;
a suction end adapter including a one-way valve connected to the distal end of the holding chamber;
a plug adapter including a one-way valve coupled over the inlet end of the filtration chamber;
a support adapter coupled to the proximal end of the holding chamber and including an opening in a cap portion in which the filtration chamber is slidably received;
an outlet adapter coupled over the outlet end of the filtration chamber, and a tubular member connectable to the outlet adapter; and
a pre-filter connected to the suction end adapter, said pre-filter having an adapter portion configured to be received in an opening in an outer cap portion of the suction end adapter and securable by a friction fit, a channel extending through the adapter portion, and a filter member secured to the outer end of the adapter portion through which water to be filtered must pass before entering the channel in the adapter portion;
wherein water is drawn through the one-way inlet valve in the suction end adapter by a negative pressure created when the filtration chamber is withdrawn from the holding chamber, and water in the holding chamber is forced through the one-way valve in the plug adapter into the filtration chamber by positive pressure created when the filtration chamber is telescoped back into the holding chamber, where the water is passed across the filter media before exiting the filtration chamber through the outlet adapter; and
wherein the pre-filter is adapted to be removable from the suction end adapter and the adapter portion alternatively connected to a free end of the tubular member connected to the outlet adapter, and wherein the channel in the adapter portion is dimensioned to snugly receive an outer end of the tubular member in the channel where it is secured by a friction fit, enabling cleaning of debris from the pre-filter by reverse flushing water through said pre-filter.

2. The portable water filtration device of claim 1 further comprising a window formed in at least a portion of a side wall of the filtration chamber through which water in the filtration chamber passing through the filter media is visible.

3. The portable water filtration device of claim 2 wherein the filter media further comprises a pleated filter membrane containing electropositively charged nano alumina fibers.

4. The portable water filtration device of claim 1 wherein the outlet adapter further comprises a pair of opposite outwardly extending finger grips connected to the outlet adapter to facilitate manual gripping of the filtration chamber particularly when manually sliding the filtration chamber in and out of the holding chamber.

5. The portable water filtration device of claim 1 further comprising a nipple adapter having an inner section and an outwardly directed nipple, said inner section configured to be attached to the outer cap portion of the suction end adapter.

6. The portable water filtration device of claim 5 further comprising an extension hose configured to be connected to the nipple adapter when attached to the suction end adapter on the distal end of the holding chamber.

7. The portable water filtration device of claim 6 wherein the pre-filter is configured to be alternatively connected to a free end of the extension hose.

8. The portable water filtration device of claim 1 further comprising a band member configured to be secured over tubular member attached to the outlet adapter for holding the tubular member in a desired position for directing the flow of water out of the tubular member while the user is manually gripping and operating the filtration device with both hands.

9. The portable water filtration device of claim 8 further comprising a surface area on the band member adapted for receiving one or more advertising indicia.

10. The portable water filtration device of claim 1 wherein an outer diameter of the tubular member connectable to the outlet adapter is slightly less than an inner diameter of the channel in the adapter portion of the pre-filter.

11. The portable water filtration device of claim 10 further comprising a gasket on an outer diameter of the outlet portion of the pre-filter.

12. A portable water filtration device comprising:
an elongated holding chamber having a distal end and a proximal end;
a filtration chamber having an inlet end and an outlet end, said filtration chamber configured to be telescoping with said holding chamber and containing at least one filter media;
a suction end adapter including a one-way valve connected to the distal end of the holding chamber, and an outer cap section;
a plug adapter including a one-way valve coupled over the inlet end of the filtration chamber;
a support adapter coupled to the proximal end of the holding chamber and including an opening in a cap portion in which the filtration chamber is slidably received;
an outlet adapter coupled over the outlet end of the filtration chamber, the outlet adapter having a cap section configured to fit over the outlet end, an outwardly directed nipple member connected to a top of the cap section, and a pair of opposite outwardly extending finger grips connected to a side wall of the cap section to facilitate manual gripping of the filtration chamber particularly when manually sliding the filtration chamber in and out of the holding chamber; and
a tubular member connectable to the nipple member of the outlet adapter;
wherein water is drawn through the one-way inlet valve in the suction end adapter by a negative pressure created when the filtration chamber is withdrawn from the holding chamber, and water in the holding chamber is forced through the one-way valve in the plug adapter into the filtration chamber by positive pressure created when the filtration chamber is telescoped back into the holding chamber, where the water is passed across the filter media before exiting the filtration chamber through the outlet adapter.

13. The portable water filtration device of claim 12 further comprising a pre-filter connected to the suction end adapter, said pre-filter having an adapter portion configured to be received in an opening in the outer cap portion of the suction end adapter and securable by a friction fit, a channel extending through the adapter portion, and a filter member secured to the outer end of the adapter portion through which water to be filtered must pass before entering the channel in the adapter portion;
wherein the pre-filter is adapted to be removable from the suction end adapter and the adapter portion alternatively connected to a free end of the tubular member connected to the outlet adapter, and wherein the channel in the adapter portion is dimensioned to snugly receive an outer end of the tubular member in the channel where it is secured by a friction fit, enabling cleaning of debris from the pre-filter by reverse flushing water through said pre-filter.

14. The portable water filtration device of claim 13 further comprising a window formed in at least a portion of a side wall of the filtration chamber through which water in the filtration chamber passing through the filter media is visible.

15. The portable water filtration device of claim 13 wherein the filter media further comprises a pleated filter membrane containing electropositively charged nano alumina fibers.
